(19) United States
(12) Patent Application Publication
(10) Pub. No.: US 2015/0291446 A1
(43) Pub. Date: Oct. 15, 2015

(54) CO-EXTRUSION METHOD FOR MAKING CARBON-SUPPORTED TRANSITION METAL-BASED NANOPARTICLES

(71) Applicant: Corning Incorporated, Corning, NY (US)

(72) Inventors: William Peter Addiego, Big Flats, NY (US); Benedict Yorke Johnson, Horseheads, NY (US); Lingyan Wang, Horseheads, NY (US)

(73) Assignee: Corning Incorporated, Corning, NY (US)

(21) Appl. No.: 14/252,174

(22) Filed: Apr. 14, 2014

(51) Int. Cl. C02F 1/28

(52) U.S. Cl. CPC C02F 1/281; C02F 2101/20

(57) ABSTRACT

The disclosure relates to methods for making carbon-supported transition metal-based nanoparticles, comprising (a) mixing at least one carbon feedstock, at least one transition metal-containing feedstock, at least one organic binder, and at least one resin binder to form a feedstock mixture, (b) extruding the feedstock mixture, and (c) heating the extruded feedstock mixture at a temperature and for a time sufficient to carbothermally reduce the transition metal-containing feedstock. Also disclosed herein are carbon-supported transition metal-based nanoparticles produced by such methods. Further disclosed herein are methods for treating water and waste streams comprising contacting the water or waste streams with the carbon-supported transition metal-based nanoparticles.

### FIELD OF THE DISCLOSURE

The present disclosure relates generally to methods for making carbon-supported transition metal-based nanoparticles and methods for treating water and other industrial process streams using the carbon-supported transition metal-based nanoparticles.

### BACKGROUND

Environmental remediation processes are useful in a wide variety of industrial applications, ranging from mining and coal applications to the treatment of ground water, wastewater, and other industrial process streams. Transition metal-based nanoparticles, such as zero-valent iron nanoparticles (ZVIN) and magnetite, have emerged as an alternative for environmental remediation due to their high surface area and high reactivity. Because transition metal-based nanoparticles possess various chemical properties derived from their different oxidation states, they have the ability to degrade a wide variety of toxic pollutants in soil and water, such as perchloroethene (PCE), trichloroethene (TCE), carbon tetrachloride (CT), nitrate, energetic munitions such as TNT and RDX, legacy organohalide pesticides such as lindane and DDT, as well as heavy metals such as chromium, lead, mercury, cadmium, and other inorganics such as selenium and arsenic. Processes employing transition metal-based nanoparticles may also provide cost savings as compared to conventional pump-and-treat or permeable reactive barrier methods.

Despite advances in transition metal-based remediation technology, such processes are not widely used in the industry due to several disadvantages, such as high operating costs, reuse and recovery difficulties, and/or aggregation effects on capacity and reactivity. These drawbacks can add complexity and cost to the overall remediation process.

Moreover, the known methods for synthesizing transition metal-based nanoparticles, such as chemical vapor deposition, inert gas condensation, pulsed laser ablation, spark discharge generation, sputtering gas aggregation, thermal decomposition, thermal reduction of oxide compounds, hydrogenation of metallic complexes, and aqueous reduction of iron salts, tend to employ expensive reagents, produce large volumes of hydrogen gas, consume large amounts of energy, and/or cannot be scaled up for industrial application due to aggregation.

Carbothermal reduction methods may potentially be employed for the economical manufacture of transition metal-based nanoparticles. Carbothermal reduction methods may, for example, be used for the large scale production of various metals and alloys. For example, silicon, ferrosilicon, aluminum, iron, steel, and tungsten may be produced by reduction of metal oxides with a carbonaceous reducing agent in an electric arc furnace. Thermal energy is used to decompose the carbonaceous materials, which in turn drives the reduction of the metal oxide particles. The reaction is attractive as a scalable process because it is endothermic and yields only gaseous by-products. However, carbothermal methods for processing free-standing transition metal-based nanoparticles still suffer from other drawbacks mentioned above, and therefore do not offer a completely feasible solution for the production of transition metal-based nanoparticles.

Accordingly, it would be advantageous to provide an efficient, cost-effective, easily operable, and/or scalable process for making transition metal-based nanoparticles. The resulting transition metal-based nanoparticles can be used in a wide variety of environmental remediation applications, such as ground water and wastewater treatment.

### SUMMARY

The disclosure relates, in various embodiments, to methods for making a carbon support comprising transition metal-based nanoparticles, comprising (a) mixing at least one carbon feedstock, at least one transition metal-containing feedstock, at least one organic binder, and at least one resin binder to form a feedstock mixture, (b) extruding the feedstock mixture, and (c) heating the extruded feedstock mixture at a temperature and for a time sufficient to carbothermally reduce the transition metal-containing feedstock. Also disclosed herein are carbon supports comprising transition metal-based nanoparticles produced by such methods. Further disclosed herein are methods for treating water and waste streams comprising contacting the water or waste streams with the carbon support comprising transition metal-based nanoparticles.

Carbon-supported transition metal-based nanoparticles produced as set forth herein may provide a high surface area useful for the efficient removal of heavy metals and other contaminants via reduction and adsorption. Moreover, the products may be molded into different shapes, which can be easily recycled and reactivated. Additionally, products having different oxidation states may be created by controlling the processing parameters, such as temperature and time. Finally, the intimate mixing of the carbon and transition metal-containing feedstocks may allow for the immobilization of the transition metal particles in an activated carbon structure, which may prevent agglomeration and bulk oxidation issues that typically arise in the case of free-standing transition metal-based nanoparticles. It should be noted, however, that one or more of such characteristics may not be present according to various embodiments of the disclosure, yet such embodiments are intended to fall within the scope of the disclosure.

Additional features and advantages of the invention will be set forth in the detailed description which follows, and in part will be readily apparent to those skilled in the art from that description or recognized by practicing the invention as described herein, including the detailed description which follows, the claims, and the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the invention.

### BRIEF DESCRIPTION OF THE DRAWINGS

The following detailed description can be best understood when read in conjunction with the following drawings, where like structures are indicated with like reference numerals and in which:

FIG. 1 is the XRD spectrum of a carbon support comprising iron oxide nanoparticles produced according to one embodiment of the disclosure;

FIG. 2 is the EDX spectrum of a carbon support comprising iron oxide nanoparticles produced according to one embodiment of the disclosure;

FIG. 3 is the XRD spectrum of a carbon support comprising zero-valent iron nanoparticles produced according to one embodiment of the disclosure;

FIG. 4 is the EDX spectrum of a carbon support comprising zero-valent iron nanoparticles produced according to one embodiment of the disclosure;

FIG. 5 is the XRD spectrum of a carbon support comprising zero-valent iron nanoparticles produced according to one embodiment of the disclosure;

FIG. 6 is the XRD spectrum of a carbon support comprising zero-valent iron nanoparticles produced according to one embodiment of the disclosure;

FIG. 7A is the XRD spectra of a carbon support comprising zero-valent iron nanoparticles produced according to one embodiment of the disclosure after immersion in water; and

FIG. 7B is the XRD spectra of a carbon support comprising zero-valent iron nanoparticles produced according to one embodiment of the disclosure after immersion in water and subsequent heat treatment.

### DETAILED DESCRIPTION

Disclosed herein are methods for making a carbon support comprising transition metal-based nanoparticles, comprising (a) mixing at least one carbon feedstock, at least one transition metal-containing feedstock, at least one organic binder, and at least one resin binder to form a feedstock mixture, (b) extruding the feedstock mixture, and (c) heating the extruded feedstock mixture at a temperature and for a time sufficient to carbothermally reduce the transition metal-containing feedstock. Also disclosed are carbon-supported transition metal-based nanoparticles prepared according to the methods disclosed herein, and methods for treating waste or water streams using the carbon-supported transition metal-based nanoparticles.

### Materials

According to various embodiments, the carbon feedstock may comprise carbon precursors, carbonized materials, and mixtures thereof. Exemplary carbon precursors include natural materials such as nut shells, wood, sawdust, biomass, and non-lignocellulosic sources. For instance, the carbon precursor can be chosen from edible grains such as wheat flour, walnut flour, pecan flour, cherry pit flour, corn flour, corn starch, corn meal, rice flour, and potato flour. Other non-limiting examples of carbon precursors include rice hulls, coconut husks, beets, millet, soybean, barley, and cotton. The carbon precursor can be derived from a crop or plant that may or may not be genetically-engineered. Carbonized materials may include, for example, coal, graphite, and coke, or any carbonized material derived from a carbon precursor disclosed herein.

Further exemplary carbon precursors and associated methods of forming carbonized materials are disclosed in commonly-owned U.S. Pat. Nos. 8,198,210, 8,318,356, and 8,482,901, and U.S. Patent Application Publication No. 2010/0150814, all of which are incorporated herein by reference in their entireties.

Suitable transition metal-containing feedstocks may comprise, for example, salts and/or oxides of one or more transition metals and combinations thereof. The transition metals may be chosen from any metals having more than one oxidation state, for instance, iron, zinc, titanium, nickel, copper, zirconium, cobalt, manganese, and combinations thereof. The transition metals may, in various embodiments, be in any oxidation state greater than zero, for instance +1, +2, +3, +4, +5, +6, +7, or +8, and combinations thereof. Suitable salts may include, for example, oxalates, nitrates, nitrites, chlorides, fluorides, sulfates, phosphates, carbonates, and citrates, hydrates thereof, and combinations thereof. Non-limiting examples of transition metal-containing feedstock materials include the salts and oxides of Fe(II), Fe(III), Cu(I), Cu(II), Ti(IV), Co(II), Co(III), Co(IV), Ni(II), Ni(IV), Zn(II), Mn(II), Mn(IV), and Zr(IV). For example, the transition metal-containing feedstock may comprise Fe(II) oxalate, Fe(NO₃)₃, Fe₂O₃, Fe₃O₄, Zr(SO₄)₂, ZrO(NO₃)₂, MnO₂, and combinations thereof.

Binders suitable for use in accordance with the instant disclosure may be chosen, for example, from organic binders, resin binders, and combinations thereof. In various embodiments, the organic binders may include cellulose ethers, such as methylcellulose, hydroxybutylcellulose, ethylcellulose, hydroxybutylmethylcellulose, hydroxyethylcellulose, hydroxymethylcellulose, hydroxypropylcellulose, hydroxypropylmethylcellulose, hydroxyethylmethylcellulose, and sodium carboxymethylcellulose. Organic binders may serve several functions aside from binding the feedstock mixture. For example, the organic binder may serve as an extrusion aid by plasticizing the feedstock mixture and may provide wet strength to help maintain the structural integrity of the green extruded shape before firing.

Organic binders may be substantially or completely removed from the mixture during heat treatment; therefore it may be advantageous, in certain embodiments, to include a resin binder which is not substantially or completely removed during firing. Such a resin binder may thus serve as a permanent binder that can hold the carbon particles and transition metal-based nanoparticles together even after firing. The resin binder may, in various embodiments, be soluble or dispersible in water and/or organic liquids present in the feedstock mixture. The resin binder may also serve the additional function of a supplemental carbon source. Suitable resin binders include, for example, thermosetting resins and thermoplastic resins, such as polyvinylidene chloride, polyvinyl chloride, polyvinyl alcohol, and the like. In various embodiments, the resin binder may be chosen from phenolic resins. Phenolic resins may, in some embodiments, offer additional advantages such as low viscosity, high carbon yield, high degree of cross-linking upon curing, and/or lower cost, although such advantages may not be present according to at least certain embodiments. Non-limiting examples of suitable phenolic resins include resole resins, such as GP® 510D50 from Georgia Pacific and Durite® from Borden Chemical Company.

In various exemplary embodiments, the feedstock mixture may comprise at least one other known component useful for mixing, plasticizing, extruding, forming, activating, carbothermally reducing, or firing the carbon-supported transition metal-based nanoparticles. For example, the feedstock mixture may further comprise at least one additional component chosen from solvents, surfactants, lubricants, pore formers, and chemical oxidizing agents such as phosphoric acid.

Solvents may, for example, be used to wet the feedstock components and/or to provide a medium in which the binders can dissolve, thus providing plasticity to the feedstock mixture. In various exemplary embodiments, the at least one solvent may be aqueous, for example water and water-miscible solvents, or organic, or any combination thereof.

The feedstock mixture may optionally further comprise at least one surfactant. Non-limiting examples of surfactants that can be used in accordance with various embodiments according to the disclosure include C₈-C₂₂ fatty acids and derivatives thereof; C₈-C₂₂ fatty esters and derivatives thereof; C₈-C₂₂ fatty alcohols and derivatives thereof; and combinations thereof. In certain exemplary embodiments, the at least one surfactant may be chosen from stearic acid, lauric acid, oleic acid, linoleic acid, palmitoleic acid, ammonium lauryl sulfate, derivatives thereof, and combinations thereof. According to certain non-limiting embodiments, the at least one surfactant may be present in the feedstock mixture in an amount ranging from about 0.5% to about 2% by weight, such as less than about 1% by weight, including all ranges and subranges therebetween.

The feedstock mixture may optionally further comprise at least one lubricant. For example, the feedstock mixture may comprise at least one oil lubricant chosen from light mineral oil, corn oil, high molecular weight polybutenes, polyol esters, blends of light mineral oils and wax emulsions, blends of paraffin wax in corn oil, and combinations thereof. The at least one lubricant may be present in the feedstock mixture, in certain embodiments, in an amount ranging from about 0.5% to about 5% by weight, for example from about 1% to about 4%, or about 2% to about 3%, by weight, including all ranges and subranges therebetween.

According to various embodiments, the feedstock mixture further comprises at least one pore former. Suitable pore formers include any particulate substance that burns out of the green extrudate during firing to create pores in the fired product. Examples of pore formers include, but are not limited to, starch pore formers, such as corn, barley, bean, potato rice, tapioca, pea, sago palm, wheat, canna, and walnut shell flours, and combinations thereof. According to at least one embodiment, the at least one pore former may serve a dual function as a carbon feedstock and as a pore former. In various non-limiting embodiments, the at least one pore former is present in the feedstock mixture in an amount ranging from about 5% to about 30% by weight, for example, from about 10% to about 30%, or from about 15% to about 25%, by weight.

The total liquid addition to the feedstock mixture may vary depending, for example, upon the types and amounts of components employed. The liquid components are added in an amount sufficient to obtain a plasticized, extrudable batch composition. By way of non-limiting example, the total liquid addition may range from about 10% by weight to about 50% by weight relative to the total weight of the feedstsock mixture (e.g., about 10%, 15%, 20%, 25%, 30%, 35%, 40%, 45%, or 50%), for example, from about 15% to about 45%, from about 20% to about 40%, or from about 25% to about 35% by weight, including all ranges and subranges therebetween.

### Methods

A feedstock mixture may be prepared by any method known that combines the carbon feedstock with the at least one transition metal-containing feedstock, the at least one organic binder, and the at least one resin binder. For example, in certain non-limiting embodiments, the two or more feedstock components may be dry mixed, followed by the liquid addition of one or more additional feedstock components. According to various embodiments, the carbon feedstock and transition metal-containing feedstock may be dry blended with the organic binder, followed by the liquid addition of the resin binder. In other embodiments, the transition metal-containing feedstock may be incorporated as an aqueous solution, and the concentration of the solution may range from about 10 to about 90 wt %. Various alternative orders and combinations may be used and are envisioned to obtain a plasticized, extrudable feedstock mixture. These alternatives are within the ability of one skilled in the art and are intended to fall within the scope of this disclosure. The mixing and/or plasticization of the feedstock mixture may take place in any suitable mixer in which the feedstock mixture will be plasticized. For example, a ribbon mixer, twin-screw extruder/mixer, auger mixer, muller mixer, or double arm mixer may be used.

The carbon feedstock, transition metal-containing feedstock, organic binder, and resin binder may be combined in any suitable ratio to form the feedstock mixture. The specific concentrations and component ratios may depend, for example, on the physical form and type of each component and their concentration, if one or more components are in the form of a mixture or solution. By way of non-limiting example, the at least one carbon feedstock may be present in an amount ranging from about 15% to about 40% by weight, relative to the total weight of the feedstock mixture (e.g., about 15%, 20%, 25%, 25%, 30%, 35%, or 40%), for example from about 20% to about 35% by weight, or from about 25% to about 30% by weight, including all ranges and subranges therebetween. The carbon feedstock may be a mixture of carbon precursors and carbonized materials. For instance, the carbon feedstock may comprise a 50/50 mixture by weight of carbon precursor and a carbonized material, such as graphite or activated carbon. In certain embodiments, the carbon feedstock may comprise up to about 50% by weight of a carbonized material, for example, up to about 35% by weight, or up to about 20% by weight, including all ranges and subranges therebetween.

The at least one transition metal-containing feedstock may be present in the feedstock mixture in an amount ranging from about 15% to about 40% by weight, relative to the total weight of the feedstock mixture (e.g., about 15%, 20%, 25%, 25%, 30%, 35%, or 40%), for example from about 20% to about 35% by weight, or from about 25% to about 30% by weight, including all ranges and subranges therebetween. The transition metal-containing feedstock may likewise comprise a combination of various components, such as transition metal salts and oxides in varying ratios, which one skilled in the art has the ability to select based on the particular application.

The at least one organic binder may be present in the feedstock mixture in an amount ranging from about 1% to about 15% by weight, relative to the total weight of the feedstock mixture (e.g., about 1%, 2%, 3%, 4%, 5%, 6%, 7%, 8%, 9%, 10%, 11%, 12%, 13%, 14%, or 15%), such as from about 2% to about 5% by weight, from about 3% to about 8% by weight, or from about 5% to about 10% by weight, including all ranges and subranges therebetween. The at least one resin binder may be present in an amount ranging from about 15% to about 40% by weight, relative to the total weight of the feedstock mixture (e.g., about 15%, 20%, 25%, 25%, 30%, 35%, or 40%), for example from about 20% to about 35% by weight, or from about 25% to about 30% by weight, including all ranges and subranges therebetween. The ratio of organic binder to resin binder may vary according to the particular application and, in some embodiments, may range from about 1:40 to about 1:1, such as from about 1:10 to about 1:2 or from about 1:8 to about 1:5.

The feedstock components may optionally be further prepared before, during, or after mixing, by any known treatment step, for example, by milling or grinding the particles. For instance, the carbon feedstock and/or the at least one transition metal-containing feedstock may be separately milled and then optionally mixed together. In other embodiments, the feedstock mixture may be simultaneously milled during mixing of the carbon feedstock and at least one transition metal-containing feedstock. According to further embodiments, the feedstock mixture may be milled after the carbon feedstock and transition metal-containing feedstock are mixed together.

By way of non-limiting example, the carbon feedstock particles may be milled to an average particle size of less than about 100 microns, for instance, less than about 75, 50, 25, 10, or 5 microns, including all ranges and subranges therebetween. In various embodiments, the carbon feedstock can have an average particle size of less than about 5 microns, such as less than about 4, 3, 2, or 1 microns, including all ranges and subranges therebetween. In further embodiments, the average particle size of the carbon feedstock may range from about 0.5 to about 25 microns, such as from about 0.5 microns to about 5 microns.

The transition metal-containing feedstock may likewise be milled to an average particle size of less than about 10 microns, for example, less than about 5, 4, 3, 2, or 1 microns, including all ranges and subranges therebetween. In various embodiments, the transition metal-containing feedstock may have an average particle size ranging from about 0.1 to about 1 micron, such as from about 0.5 to about 1 micron.

After all components have been combined, the feedstock mixture may then be extruded according to any method known in the art to form any suitable shape having the desired dimensions. According to various embodiments, the carbon feedstock and transition metal-containing feedstock are co-extruded together as a feedstock mixture to form a substantially homogeneous extrudate. The feedstock mixture may be extruded either vertically or horizontally and the extruder may optionally employ a die. For example, various dies may be employed to form an extrudate having a shape chosen from honeycombs, monoliths, rods, ribbons, and the like. The extrusion may, in some embodiments, be performed using a hydraulic ram extrusion press, a two-stage de-airing single auger extruder, or a twin-screw mixer with a die assembly attached to the discharge end. The proper screw elements may be chosen according to the feedstock components and other process conditions so as to build up sufficient pressure to force the feedstock mixture through the die.

The extrudate may then be optionally dried by any conventional method known to those skilled in the art to form a green body. For instance, the extrudate may be dried using ambient air, humid air, and/or hot air, or may be dried by dielectric drying, microwave drying, reduced pressure drying, vacuum drying, and/or freeze drying. According to various embodiments, the extrudate may be dried at a temperature ranging from about 50° C. to about 200° C., such as from about 50° C. to about 150° C., or from about 90° C. to about 120° C., including all ranges and subranges therebetween. The drying time may range, for example, from about 1 hour to about 10 hours, such as from about 2 hours to about 8 hours, from about 3 hours to about 3 hours, or from about 4 hours to about 5 hours, including all ranges and subranges therebetween. By way of non-limiting example, the extrudate may be humidity dried at a relative humidity up to about 90%, at a temperature ranging from about 40° C. to about 90° C., and for a time ranging from about 4 hours to about 4 days or more.

In various exemplary embodiments, the extrudate may then be heat treated to carbothermally reduce the transition metal-containing feedstock. As used herein, “carbothermal reduction,” “carbothermally reduce,” “carbothermally reduced” and variations thereof are intended to denote that the transition metal-containing feedstock is partially, substantially, or, in some embodiments, completely reduced so as to form a zero valent transition metal and/or transition metal oxide. By way of non-limiting example, an Fe(III) salt may be reduced either to an iron oxide (Fe₂O₃ or Fe₃O₄) or to zero-valent iron Fe⁰. Similar reductions using other transition metals are envisioned and within the scope of the disclosure.

It is within the ability of one skilled in the art to determine the appropriate method and conditions for the carbothermal reduction, such as, for example, firing conditions including equipment, temperature and duration. Such methods and conditions may depend, for example, upon the size and composition of the extrudate, as well as the desired properties of the resulting product.

By way of non-limiting example, the extrudate may be heat treated in an inert or reducing atmosphere. Examples of inert or reducing gases and gas mixtures include one or more of hydrogen, nitrogen, ammonia, helium and argon. In one exemplary embodiment, the extrudate can be heated at a temperature ranging from about 500° C. to about 950° C. (e.g., about 500, 550, 600, 650, 700, 750, 800, 850, 900 or 950° C., and all ranges and subranges therebetween) for a predetermined time (e.g., about 0.5, 1, 2, 4, 5, 8, 10 or more hours, and all ranges and subranges therebetween). In various embodiments, the heat treatment may be performed using a conventional furnace or by heating within a microwave reaction chamber using microwave energy. For instance, the extrudate may be heat treated using an AC or DC electric arc furnace.

During the heat treatment step, any carbon precursor present in the carbon feedstock may be substantially or completely reduced and decomposed to form activated carbon. Additionally, the transition metal-containing feedstock is carbothermally reduced to form a zero-valent transition metal and/or a transition metal oxide. An activated carbon support comprising transition metal oxide or zero-valent transition metal nanoparticles can thus be produced using the methods disclosed herein.

After heat treatment, the carbon support comprising transition metal-based nanoparticles may be optionally further treated, for example, the support may be cooled, rinsed with water, treated with acid, and/or stored under ambient or inert conditions. In certain embodiments, the support may be cooled and/or stored in an inert atmosphere to prevent oxidation. In other embodiments, the support may be treated with acid prior to use, to remove any oxidized layer that may have formed on the support during storage. For instance, if the support is stored under ambient conditions, it may be acid treated prior to use, for example, by treating the support with hydrochloric acid. The concentration of the acid and the treatment time will vary depending on the support and the conditions under which it was stored.

### Carbon-Supported Transition Metal-Based Nanoparticles

The disclosure also relates to carbon supports comprising transition metal-based nanoparticles produced according to the methods disclosed herein. Such supports may have any desired shape or size, including honeycombs, monoliths, rods, and ribbons. In other embodiments, after extrusion and firing, the support may be ground into a powder to increase the surface interaction with the water or waste stream to be treated.

By way of non-limiting example, the carbon-supported transition metal-based nanoparticles may comprise activated carbon particles having, for instance, an average particle size of less than about 100 microns, for instance, less than about 75, 50, 25, 10, or 5 microns, including all ranges and subranges therebetween. In various embodiments, the activated carbon may have an average particle size of less than about 5 microns, such as less than about 4, 3, 2, or 1 microns, including all ranges and subranges therebetween. In further embodiments, the average particle size of the activated carbon may range from about 0.5 to about 25 microns, such as from about 0.5 microns to about 5 microns.

The activated carbon can comprise micro-, meso- and/or macroscale porosity. As defined herein, microscale pores have a pore size of about 2 nm or less and ultra-microscale pores have a pore size of about 1 nm or less. Mesoscale pores have a pore size ranging from about 2 to about 50 nm. Macroscale pores have a pore size greater than about 50 nm. In one embodiment, the activated carbon comprises a majority of microscale pores.

As used herein, the term “microporous carbon” and variants thereof means an activated carbon having a majority (i.e., at least 50%) of microscale pores. A microporous, activated carbon material can comprise greater than 50% microporosity (e.g., greater than about 50, 55, 60, 65, 70, 75, 80, 85, 90 or 95% micro porosity). According to certain embodiments, the activated carbon may have a total porosity of greater than about 0.2 cm³/g (e.g., greater than about 0.2, 0.25, 0.3, 0.35, 0.4, 0.45, 0.5, 0.55, 0.6, 0.65 or 0.7 cm³/g). The portion of the total pore volume resulting from micropores (d 2 nm) can be about 90% or greater (e.g., at least about 90, 94, 94, 96, 98 or 99%) and the portion of the total pore volume resulting from micropores (d 1 nm) can be about 50% or greater (e.g., at least about 50, 55, 60, 65, 70, 75, 80, 85, 90 or 95%). The activated carbon may have a total surface area ranging, for example, from about 200 m²/g to about 10,000 m²/g, such as from about 500 m²/g to about 5,000 m²/g, or from about 1,000 m²/g to about 3,000 m²/g, including all ranges and subranges therebetween.

According to various embodiments, the carbon-supported transition metal-based nanoparticles consist of activated carbon and transition-metal based nanoparticles. In other embodiments, the carbon-supported transition metal-based nanoparticles consist essentially of activated carbon and transition-metal based nanoparticles. For instance, in certain embodiments, the carbon-supported transition metal-based nanoparticles may comprise carbon precursor materials that are not fully activated during the heat treatment step and/or various organic or inorganic impurities that do not burn out during the heat treatment step. According to various embodiments, the carbon-supported transition metal-based nanoparticles may comprise up to, for instance, about 10% by weight of such precursors and/or impurities, such as up to about 5%, up to about 4%, up to about 3%, up to about 2%, up to about 1%, up to about 0.5%, or up to about 0.1% by weight of carbon precursors and/or impurities.

The carbon support may, in certain embodiments, comprise the transition metal-based nanoparticles in a concentration ranging, for example, from about 1% to about 40% by weight (e.g., about 5%, 10%, 15%, 20%, 25%, 30%, 35%, or 40%), such as from about 15% to about 35%, from about 10% to about 30%, or from about 5% to about 25% by weight, including all ranges and subranges therebetween.

As used herein, the term “nanoparticles” is meant to denote particles having a size less than one micron, for example, ranging from about 1 nm to about 999 nm, such as from about 10 nm to about 900 nm, from about 50 nm to about 800 nm, from about 100 nm to about 700 nm, from about 150 nm to about 600 nm, from about 200 nm to about 500 nm, or from about 300 nm to about 400 nm, including all ranges and subranges therebetween.

In certain embodiments, the transition-metal based nanoparticles are dispersed throughout the carbon matrix. For example, the carbon-supported transition-metal based nanoparticles may be homogenously distributed throughout the carbon matrix. In certain embodiments, the transition metal-based nanoparticles are embedded and/or enveloped in a porous carbon matrix such that at least a portion of the nanoparticles are exposed, for instance, able to interact with, bind to, and/or adsorb various impurities to which they may be exposed.

As used herein the terms “homogeneous” and “substantially homogeneous” and variations thereof are intended to denote that the carbon-supported transition metal-based nanoparticles exhibit chemical homogeneity across a length scale ranging from about 1 nanometer to about 1,000 microns. For example, the carbon-supported transition metal-based nanoparticles may be substantially homogeneous across a length scale ranging from about 10 nanometers to about 500 microns, from about 50 nanometers to about 100 microns, or from about 100 nanometers to about 1 micron, including all ranges and subranges therebetween.

Carbon-supported transition metal-based particles as produced herein can be used to treat a wide variety of water and waste streams, such as ground water, standing water, drinking water, and waste water. Numerous industrial process streams can also be treated, such as aqueous industrial waste streams. Such streams may be treated by bringing them into contact with the carbon-supported transition metal-based particles disclosed herein. According to various embodiments, the transition metal-based nanoparticles are distributed throughout a carbon support, which can be added to the stream for a time period sufficient to remove or reduce the concentration of the targeted impurity. Impurities can include, for example, toxic pollutants in soil and water, such as PCE, TCE, CT, nitrate, TNT, RDX, lindane, DDT, chromium, lead, mercury, cadmium, selenium, and arsenic.

Treatment times will vary depending on the type and amount of impurity present in the stream to be treated. By way of non-limiting example, the contact time may range from less than about 1 minute to greater than about 24 hours, for instance, from about 30 minutes to about 24 hours, such as from about 1 hour to about 20 hours, from about 4 hours to about 18 hours, from about 6 hours to about 16 hours, or from about 8 hours to about 12 hours, including all ranges and subranges therebetween.

After use, the carbon-supported transition metal-based nanoparticles may be optionally recovered from the treated stream and recycled for future use. For example, the used product can be reactivated by heat treating it to carbothermally reduce the transition metal-based nanoparticles back to a lower oxidation state or a zero valent state. The reactivated carbon support comprising transition metal-based nanoparticles can then be used repeatedly to treat other streams.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “an organic binder” includes examples having two or more such “organic binders” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Other than in the Examples, all numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a temperature greater than 50° C.” and “a temperature greater than about 50° C.” both include embodiments of “a temperature greater than about 50° C.” as well as “a temperature greater than 50° C.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon feedstock that comprises a carbon precursor include embodiments where a carbon feedstock consists of a carbon precursor, and embodiments where a carbon feedstock consists essentially of a carbon precursor.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Example 1

A feedstock mixture was prepared by mixing the components listed below in Table I.

TABLE I
Feedstock Composition for Fe—C Honeycombs

| Material | Weight (%) | Weight (g) |
|---|---|---|
| A: Carbon/Transition Metal Feedstocks | | |
| Iron (II) Oxalate | 31.0% | 359.93 |
| Walnut shell | 14.2% | 165.19 |
| Graphite | 13.9% | 160.82 |
| Total A | 59.2% | 685.94 |
| B: Solid Binders/Organics | | |
| Sodium Stearate - LIGA | 0.6% | 7.44 |
| Hydroxypropyl Methylcellulose - A4M | 2.9% | 34.13 |
| Total B | 3.5% | 41.57 |
| C: Liquid Additions Following Dry Blending | | |
| Phosphoric Acid | 1.4% | 16.63 |
| Mineral Oil | 0.7% | 8.31 |
| Phenolic Resin | 35.1% | 406.97 |
| Total C | 37.3% | 431.91 |
| TOTAL | 100% | 1159.42 |

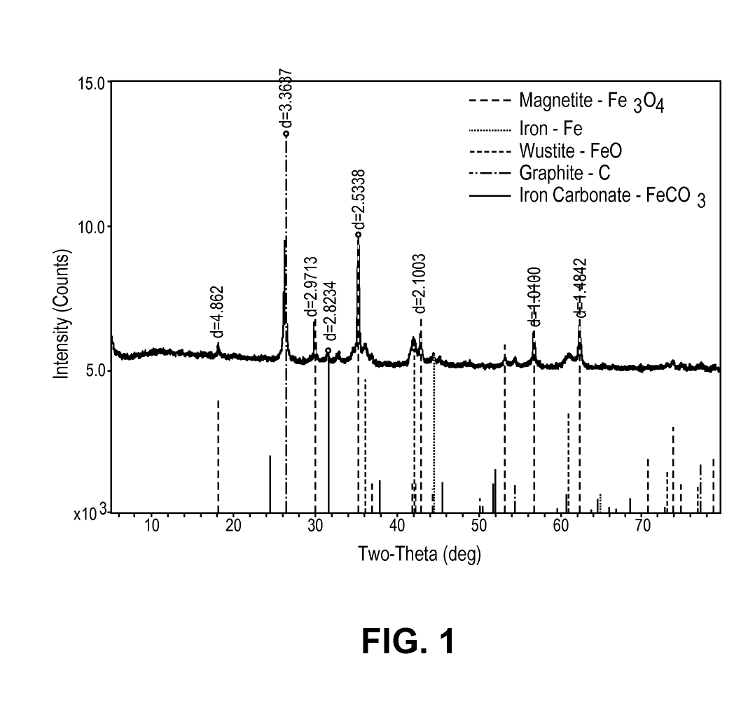

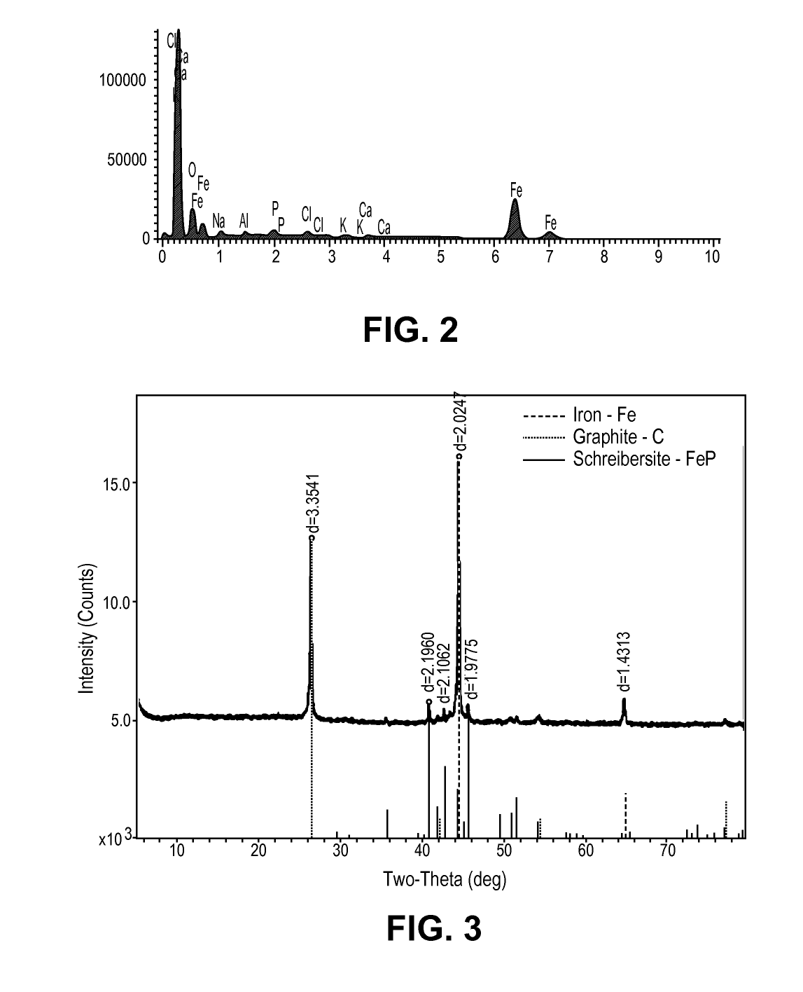

The feedstock mixture was extruded into a honeycomb shape and dried at 90° C. for 5 hours. The extrudate was subsequently heat treated for 5 hours at 600° C. under a nitrogen atmosphere. The sample was then cooled down to room temperature under a nitrogen atmosphere to prevent oxidation. X-ray diffraction (XRD) and electron microprobe analyses were performed to determine the crystalline phases present in the sample and the distribution of iron particles in the carbon matrix. FIG. 1 is the XRD spectrum of the sample, indicating that the primary phases are graphite and Fe₃O₄, with no significant presence of Fe⁰ in the final product. FIG. 2 is the energy dispersive X-ray (EDX) spectrum for the sample, indicating that carbon, iron, and oxygen are the primary elements making up the nanoparticles.

The sample was tested in real flue gas desulfurization (FGD) wastewater to evaluate its heavy metal removal performance. A honeycomb sample containing about 100 mg iron oxide was immersed in 45 ml of FGD wastewater containing 25-30 ppb As, 190-200 ppb Cd, 2-3 ppm Se, and 180-220 ppb Hg. The solution was agitated using a mechanical shaker for 6 hours. The amounts of adsorbed metal ions were calculated by measuring the difference between their concentrations before and after adsorption. Table II demonstrates that the sample was effective in removing metal cations (Hg and Cd).

TABLE II
Metal Removal Performance of Fe—C Honeycomb
(600° C. Heat Treatment)

Concentration

| Toxic Metal | Before | After |
|---|---|---|
| Mercury (Hg) | 228 ppb | <5 ppb |
| Cadmium (Cd) | 181 ppb | <5 ppb |
| Selenium (Se) | 2.2 ppm | 2.2 ppm |
| Arsenic (As) | 27 ppb | 26 ppb |

### Example 2

An Fe—C honeycomb sample was prepared in the same manner as in Example 1, except the extrudate was heat treated at 650° C. for 5 hours. FIG. 3 is the XRD spectrum of the sample, indicating that the primary phases are graphite and zero-valent iron Fe⁰, with no significant presence of iron oxide in the final product. Without wishing to be bound by theory, it is believe that 650° C. is the approximate temperature at which the iron (II) oxalate salt is completely reduced.

### Examples 3-5

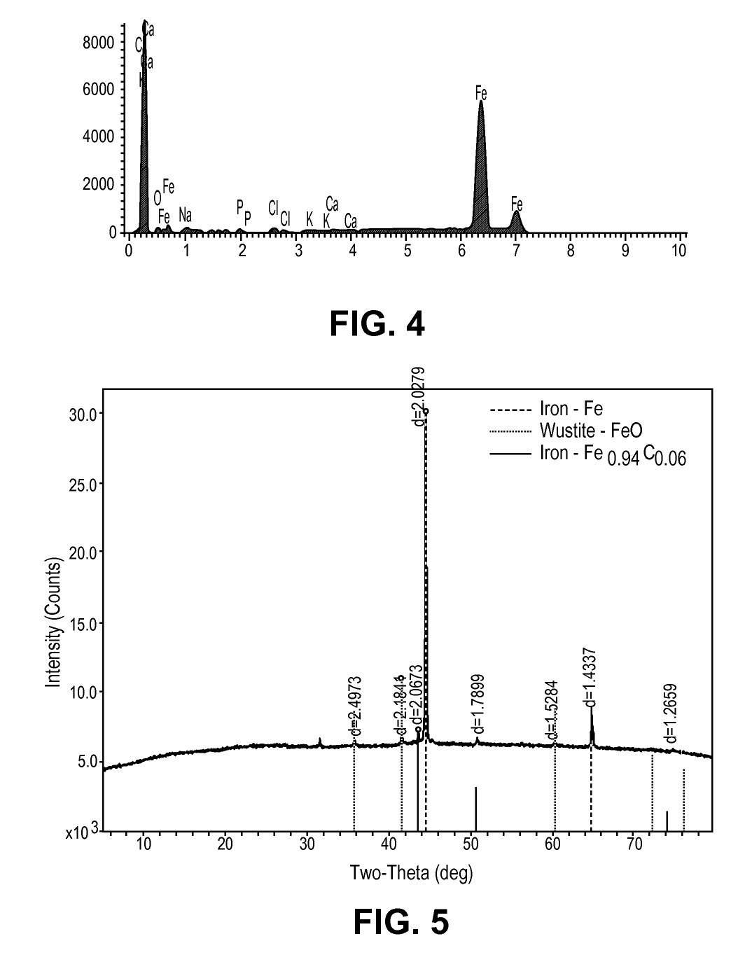

Fe—C honeycomb samples were prepared in the same manner as in Example 1, except the heat treatment temperatures were 700° C., 750° C., and 800° C., respectively. The XRD spectrums of these samples (not illustrated) were substantially similar to those obtained for the sample produced in Example 2. FIG. 4 is the energy dispersive X-ray (EDX) spectrum for the sample, indicating that indicating that carbon and iron are the primary elements making up the nanoparticles.

The sample treated at 700° C. (Example 3) was tested in real FGD wastewater in the same manner as the sample tested in Example 1. Table III demonstrates the heavy metal removal performance of this sample.

TABLE III
Metal Removal Performance of Fe—C Honeycomb
(700° C. Heat Treatment)

Concentration

| Toxic Metal | Before | After |
|---|---|---|
| Mercury (Hg) | 183 ppb | <5 ppb |
| Cadmium (Cd) | 195 ppb | 106 ppb |
| Selenium (Se) | 2.25 ppm | 1.27 ppm |
| Arsenic (As) | 29 ppb | 17 ppb |

### Example 6

While the sample in Example 3 was effective in removing mercury, and partially effective in removing cadmium, selenium, and arsenic, a higher effectiveness was expected but not observed. Without wishing to be bound by theory, it is believed that the reactivity of the sample may have been reduced during storage at ambient conditions, which may have partially oxidized the Fe⁰ nanoparticles. Accordingly, the sample from Example 3 was treated with 1.0M HCl for 15 minutes prior to the adsorption test. After the acid treatment, the sample was rinsed with deionized water until a neutral pH was achieved. The sample was then immersed in real FGD waste water. As indicated in Table IV, the acid treatment significantly increased the adsorption performance of the sample, such that it effectively removed both metal cations (Hg and Cd) and anions (Se and As). Without wishing to be bound by theory, it is believed that the acid treatment removed at least a portion of the iron oxide layer that may have formed during storage.

TABLE IV
Metal Removal Performance of Fe—C Honeycomb
(600° C. Heat Treatment + 1.0M HCl for 15 minutes)

Concentration

| Toxic Metal | Before | After |
|---|---|---|
| Mercury (Hg) | 195 ppb | 7 ppb |
| Cadmium (Cd) | 193 ppb | <5 ppb |
| Selenium (Se) | 2.15 ppm | <0.01 ppm |
| Arsenic (As) | 28 ppb | <5 ppb |

### Example 7

A feedstock mixture was prepared by mixing the components listed below in Table V.

TABLE V
Feedstock Composition for Fe-AC-BL Honeycombs

| Material | Weight (%) | Weight (g) |
|---|---|---|
| A: Carbon/Transition Metal Feedstocks | | |
| Activated Carbon - BL (1200 cm²/g) | 14.6% | 122.04 |
| Wood Flour | 14.2% | 118.80 |
| Iron (II) Oxalate | 31.2% | 260.64 |
| Total A | 60.1% | 501.48 |
| B: Solid Binders/Organics | | |
| Sodium Stearate - LIGA | 0.6% | 5.04 |
| Hydroxypropyl Methylcellulose - A4M | 3.0% | 25.20 |
| Total B | 3.6% | 30.24 |
| C: Liquid Additions Following Dry Blending | | |
| Mineral Oil | 0.9% | 7.20 |
| Phenolic Resin - GP | 35.4% | 295.20 |
| Total C | 36.3% | 302.40 |
| TOTAL | 100% | 834.12 |

The feedstock mixture was extruded into a honeycomb shape and dried at 90° C. for 5 hours. The extrudate was subsequently heat treated for 5 hours at 750° C. under a nitrogen atmosphere. The sample was then cooled down to room temperature under a nitrogen atmosphere to prevent oxidation. FIG. 5 is the XRD spectrum of the sample, indicating that the primary phase is Fe⁰, with small amounts of FeO and FeC in the final product. A size calculation based on the XRD spectrum indicated a particle size of about 160 nm for the zero-valent iron nanoparticles.

The sample was quickly screen tested in FGD wastewater to evaluate its heavy metal removal performance. Approximately 0.45 g of the honeycomb sample was immersed in 50 ml of FGD wastewater for 60 minutes. Another portion of the sample was crushed into a powder (0.45 g) and similarly screen tested. The results showed that the powdered sample had better performance, which is believed to be due to its increased surface area. Table VI demonstrates the heavy metal removal performance of the honeycomb and powder samples.

TABLE VI
Metal Removal Performance of Fe-AC Honeycomb and Powder

| Sample | As (ppb) | Cd (ppb) | Hg (ppb) | Se (ppm) |
|---|---|---|---|---|
| Control | 220 | 179 | 206 | 2.0 |
| Fe-AC-BL Honeycomb | 129 | 67 | 129 | 1.16 |
| Fe-AC-BL Powder | 11 | 14 | 97 | 0.51 |

### Example 8

A feedstock mixture was prepared by mixing the components listed below in Table VII.

TABLE VII
Feedstock Composition for Fe-AC-WPC Honeycombs

| Material | Weight (%) | Weight (g) |
|---|---|---|
| A: Carbon/Transition Metal Feedstocks | | |
| Activated Carbon - WPC (800 cm²/g) | 22.2% | 190.40 |
| Wood Flour | 0.0% | 0.00 |
| Iron (II) Oxalate | 30.0% | 257.60 |
| Total A | 52.2% | 448.00 |
| B: Pore Former | | |
| Wheat Starch | 10.8% | 92.40 |
| Total B | 10.8% | 92.40 |
| C: Solid Binders/Organics | | |
| Sodium Stearate - LIGA | 0.5% | 3.92 |
| Hydroxypropyl Methylcellulose - A4M | 2.3% | 19.60 |
| Total C | 2.7% | 23.52 |
| D: Liquid Additions Following Dry Blending | | |
| Mineral Oil | 0.7% | 5.60 |
| Phenolic Resin - GP | 33.6% | 288.40 |
| Total D | 34.3% | 294.00 |
| TOTAL | 100% | 857.92 |

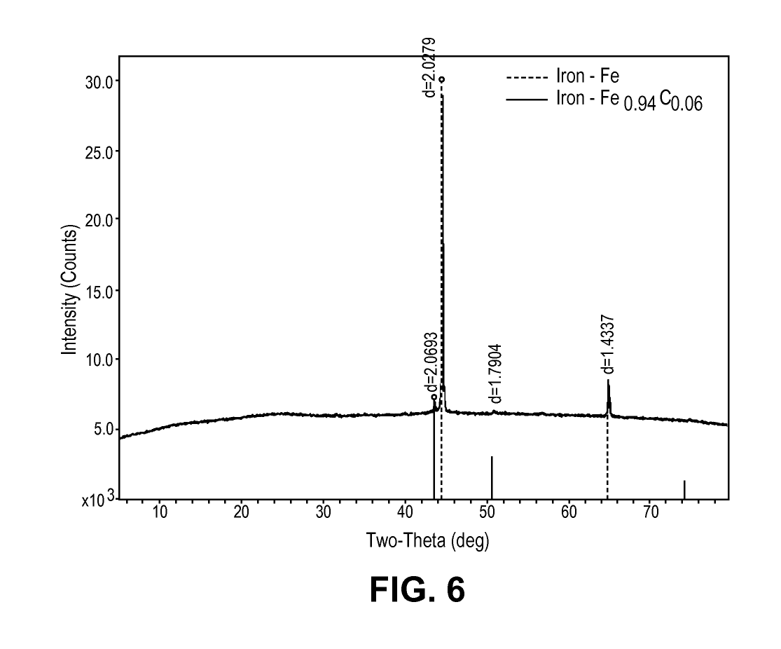

The feedstock mixture was extruded into a honeycomb shape and dried at 90° C. for 5 hours. The extrudate was subsequently heat treated for 5 hours at 750° C. under a nitrogen atmosphere. The sample was then cooled down to room temperature under a nitrogen atmosphere to prevent oxidation. FIG. 6 is the XRD spectrum of the sample, indicating that the primary phase is Fe⁰, with small amounts of FeC in the final product. A size calculation based on the XRD spectrum indicated a particle size of about 160 nm for the zero-valent iron nanoparticles.

The sample was quickly screen tested, both as a honeycomb and as a powder, in FGD wastewater to evaluate its heavy metal removal performance. The same protocol discussed in Example 7 was followed. Table VIII demonstrates the heavy metal removal performance of the honeycomb and powder samples.

TABLE VIII
Metal Removal Performance of Fe-AC Honeycomb and Powder

| Sample | As (ppb) | Cd (ppb) | Hg (ppb) | Se (ppm) |
|---|---|---|---|---|
| Control | 220 | 179 | 206 | 2.0 |
| Fe-AC-WPC | 106 | 107 | 157 | 1.67 |
| Honeycomb | | | | |
| Fe-AC-WPC Powder | 74 | 54 | 33 | 2.0 |

### Example 9

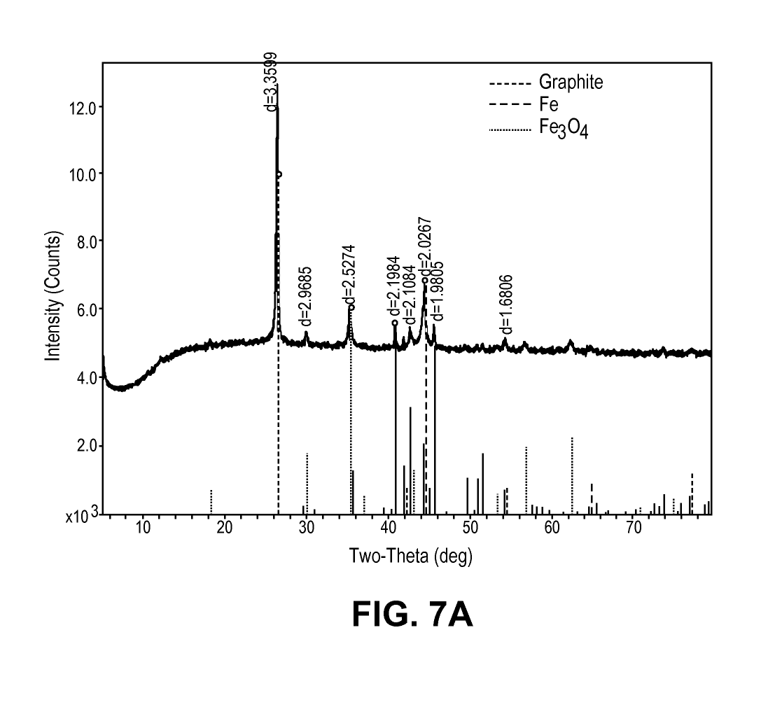

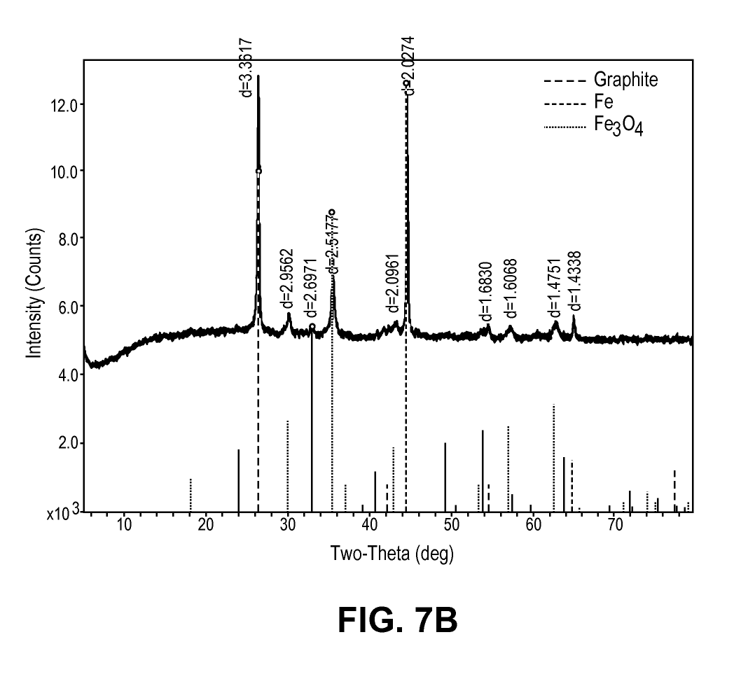

In order to demonstrate the ability to regenerate and reactivate the products disclosed herein, the sample prepared in Example 2 (650° C. heat treatment for 5 hours) was submerged in tap water for 63 days and then reactivated at 650° C. for 4 hours under a nitrogen atmosphere. FIG. 3 is the XRD spectrum of the treated sample before submersion. FIG. 7A is the XRD spectrum of the sample after submersion in water. FIG. 7B is the XRD spectrum of the sample after submersion and subsequent heat treatment. As can be appreciated by the comparison of these spectra, submersion in water oxidized the sample to produce a noticeable iron oxide phase, whereas the subsequent heat treatment was able to significantly regenerate the Fe⁰ phase. The carbon-supported transition metal-based nanoparticles produced herein can therefore be feasibly used as adsorbents for heavy metals and can be removed/reused without the need for follow up filtration, which can be expensive and difficult to operate.

What is claimed is:

1. A method for making carbon-supported transition metal-based nanoparticles, the method comprising:
(a) mixing at least one carbon feedstock, at least one transition metal-containing feedstock, at least one organic binder, and at least one resin binder to form a feedstock mixture;
(b) extruding the feedstock mixture; and
(c) heating the extruded feedstock mixture at a temperature and for a time sufficient to carbothermally reduce the at least one transition metal-containing feedstock.

2. The method of claim 1, wherein the at least one transition metal is chosen from iron, zinc, titanium, nickel, copper, zirconium, hafnium, vanadium, niobium, cobalt, manganese, platinum, aluminum, barium, bismuth, and combinations thereof.

3. The method of claim 1, wherein the at least one transition metal-containing feedstock is chosen from transition metal salts and oxides, and combinations thereof.

4. The method of claim 1, wherein the at least one transition metal-containing feedstock is chosen from FeC₂O₄, FeCO₃, Fe(NO₃)₃, Fe₂O₃, Fe₃O₄, Zr(SO₄)₂, ZrO(NO₃)₂, and combinations thereof.

5. The method of claim 1, wherein the at least one organic binder chosen from cellulose ethers.

6. The method of claim 1, wherein the at least one organic binder is chosen from methylcellulose, hydroxybutylcellulose, ethylcellulose, hydroxybutylmethylcellulose, hydroxyethylcellulose, hydroxymethylcellulose, hydroxypropylcellulose, hydroxypropylmethylcellulose, hydroxyethylmethylcellulose, sodium carboxymethylcellulose, and combinations thereof.

7. The method of claim 1, wherein the at least one resin binder is chosen from thermosetting resins, thermoplastic resins, and combinations thereof.

8. The method of claim 1, wherein the at least one resin binder is chosen from phenolic resins.

9. The method of claim 1, wherein the at least one resin binder is chosen from polyvinylidene chloride, polyvinyl chloride, polyvinyl alcohol, resole resins, and combinations thereof.

10. The method of claim 1, wherein the extruded feedstock mixture is heated at a temperature ranging from about 500° C. to about 1,000° C.

11. The method of claim 1, wherein the extruded feedstock mixture is heated for a time period ranging from about 0.5 to about 10 hours.

12. The method of claim 1, further comprising drying the extruded feedstock mixture at a temperature ranging from about 50° C. to about 200° C. and for a time ranging from about 1 hour to about 10 hours.

13. The method of claim 1, wherein the at least one carbon feedstock is present in the feedstock mixture in an amount ranging from about 15% to about 40% by weight, relative to the total weight of the feedstock mixture.

14. The method of claim 1, wherein the at least one transition metal-containing feedstock is present in the feedstock mixture in an amount ranging from about 15% to about 40% by weight, relative to the total weight of the feedstock mixture.

15. The method of claim 1, wherein the at least one organic binder is present in the feedstock mixture in an amount ranging from about 1% to about 15% by weight, relative to the total weight of the feedstock mixture.

16. The method of claim 1, wherein the at least one resin binder is present in the feedstock mixture in an amount ranging from about 15% to about 40% by weight, relative to the total weight of the feedstock mixture.

17. Carbon-supported transition metal-based nanoparticles produced by the method defined in claim 1.

18. The carbon-supported transition metal-based nanoparticles of claim 17, wherein the transition metal-based nanoparticles are present in a concentration ranging from about 15% to about 35% by weight.

19. A method for treating water or waste streams comprising contacting the water or waste streams with the carbon-supported transition metal-based nanoparticles defined in claim 17.

20. The method of claim 19, wherein the water is chosen from drinking water groundwater, standing water, and wastewater.

21. The method of claim 19, further comprising reactivating the carbon-supported transition metal-based nanoparticles by heating at a temperature and for a time sufficient to carbothermally reduce the transition metal-based nanoparticles.
